(19) United States
(12) Patent Application Publication
(10) Pub. No.: US 2025/0023113 A1
(43) Pub. Date: Jan. 16, 2025

(54) PORTABLE ELECTRONIC DEVICE BATTERY STIMULATION

(71) Applicant: Cirrus Logic International Semiconductor Ltd., Edinburgh (GB)

(72) Inventors: Aleksey S. KHENKIN, Austin, TX (US); Jon D. HENDRIX, Austin, TX (US)

(73) Assignee: Cirrus Logic International Semiconductor Ltd., Edinburgh (GB)

(21) Appl. No.: 18/352,737

(22) Filed: Jul. 14, 2023

(51) Int. Cl. H01M 10/42

(52) U.S. Cl. CPC H01M 10/4214; H01M 10/4242; H01M 2220/30

(57) ABSTRACT

A method of improving electrode wetting of a battery of a portable electronic device, the method implemented by the portable electronic device or battery-stimulation apparatus thereof, the method comprising: applying a stimulation signal, being a fluctuating or alternating electrical signal, to at least one terminal of the battery to stimulate a mechanical response of electrodes of the battery.

### FIELD OF DISCLOSURE

The present disclosure relates in general to battery stimulation, and in particular to a method of stimulating a battery of a portable electronic device and associated apparatuses and systems.

### BACKGROUND

Portable electronic devices are typically powered by batteries and may be referred to as battery-powered devices. Example portable electronic devices include cellphones, laptops, tablet computers, wearable electronic devices and power tools. Such devices may be referred to as consumer devices. Batteries for such portable electronic devices may comprise one or more battery cells, and references herein to such batteries may be considered references to the battery cell or cells concerned.

The batteries of such portable electronic devices are typically rechargeable. Portable electronic devices therefore generally comprise an onboard charger for controlling charging of their battery, with power being provided from an external power supply such as an external battery or mains power supply via a wired or wireless connection. The onboard charger may monitor battery characteristics including temperature, battery terminal voltage VB (such as battery open-circuit voltage OCV) and State-of-Charge (SOC) and control the charging rate of the battery according to a charge profile which is dependent on those characteristics. Lithium (Li) batteries, as an example, are typically charged at different charge rates depending on the temperature of the battery and on how full or empty the battery is in terms of charge (i.e. the State-of-Charge, SOC).

Storage capacity of such rechargeable batteries is of importance. Unfortunately, storage capacity may degrade over time (or over a series of charging or discharging cycles) and/or may be considered insufficient.

It is desirable to address the above problems.

### SUMMARY

According to a first aspect of the present disclosure, there is provided a method of improving electrode wetting of a battery of a portable electronic device, the method implemented by the portable electronic device or battery-stimulation apparatus thereof, the method comprising: applying a stimulation signal, being a fluctuating or alternating electrical signal, to at least one terminal of the battery to stimulate a mechanical response of electrodes of the battery.

According to a second aspect of the present disclosure, there is provided a method of improving electrode wetting of a battery of a portable electronic device, the method implemented by the portable electronic device, the method comprising applying a fluctuating or alternating electrical signal to at least one terminal of the battery.

According to a third aspect of the present disclosure, there is provided a method of stimulating a target mechanical response of a battery of a portable electronic device, the method comprising: applying a stimulation signal to at least one terminal of the battery, wherein the stimulation signal is a fluctuating or alternating electrical signal whose frequency spectrum and/or power is selected for stimulating the target mechanical response.

According to a fourth aspect of the present disclosure, there is provided a method of stimulating a target mechanical response of a battery of a portable electronic device, the method implemented by the portable electronic device, the method comprising applying a fluctuating or alternating electrical signal to at least one terminal of the battery.

According to a fifth aspect of the present disclosure, there is provided a method of improving a characteristic of a battery of a portable electronic device, the method comprising: applying a stimulation signal to at least one terminal of the battery, wherein the stimulation signal is a fluctuating or alternating electrical signal whose frequency spectrum and/or power is selected for stimulating a mechanical response of the battery.

According to a sixth aspect of the present disclosure, there is provided a battery-stimulation apparatus for use by a portable electronic device to improve electrode wetting of a battery of a portable electronic device, the apparatus configured to carry out the method of any of the preceding aspects, optionally wherein the apparatus is implemented as a single integrated circuit or as a group of integrated circuits communicatively coupled together.

According to a seventh aspect of the present disclosure, there is provided a portable electronic device comprising the battery-stimulation apparatus according to the aforementioned sixth aspect, and optionally comprising the battery. The portable electronic device may be a cellphone, laptop, tablet computer, wearable electronic device, power tool or other personal device.

Corresponding apparatus/device aspects, method aspects, computer program aspects and storage medium aspects are envisaged. Features of one aspect may be applied to another and vice versa.

### BRIEF DESCRIPTION OF THE DRAWINGS

Reference will now be made, by way of example only, to the accompanying drawings, of which:

FIG. 1 is a schematic diagram of a portable electronic device embodying the present invention;

FIG. 2 is a flow diagram of a method embodying the present invention, which may be implemented in a portable electronic device;

FIG. 3 comprises graphs showing example experimental results for use in applying the method of FIG. 2 and showing a benefit of applying the method of FIG. 2;

FIG. 4 is a schematic diagram of a portable electronic device embodying the present invention;

FIG. 5 is a flow diagram of a method which may be implemented in the portable electronic device of FIG. 4;

FIG. 6 is a graph showing example results according to the method of FIG. 5;

FIG. 7 is a schematic diagram of a system embodying the present invention, comprising a portable electronic device and a remote server; and

FIG. 8 is a schematic diagram of another system embodying the present invention, also comprising a portable electronic device and a remote server.

### DETAILED DESCRIPTION

The description below sets forth example embodiments according to this disclosure. Further example embodiments and implementations will be apparent to those having ordinary skill in the art. Further, those having ordinary skill in the art will recognize that various equivalent techniques may be applied in lieu of, or in conjunction with, the embodiments discussed below, and all such equivalents should be deemed as being encompassed by the present disclosure.

Problems can occur during battery manufacture (i.e. cell formation). One such problem is incomplete electrode wetting, in particular incomplete penetration of the electrolyte of the battery into its electrode(s). Incomplete electrode wetting can leave as much as 20% of the electrode volume effectively “dry”, having a detrimental effect on battery performance.

The inventors have recognised that mechanical cycling of a battery cell may improve electrode wetting, and thus have a positive effect on battery capacity/performance. Battery cells exhibit mechanical stress/strain in response to potential difference changes between electrodes. The inventors propose applying a varying (e.g. AC) electrical signal to at least one battery/cell terminal to generate an electrode mechanical response (i.e. a vibrational response-effectively a shaking of one or more electrodes) in an effort to improve electrode wetting.

The inventors propose to treat a battery when it is in use or in service (i.e. installed) in a portable electronic device, with the treatment preferably carried out by the portable electronic device itself. Such treatment may be referred to as in-situ treatment and may involve applying a stimulation signal to at least one of the battery terminals.

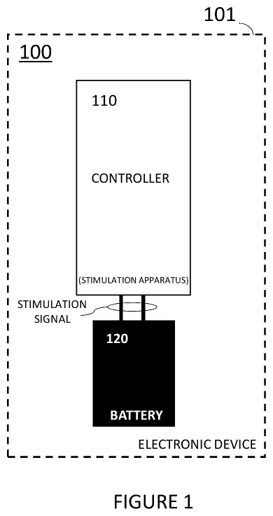

FIG. 1 is a schematic diagram of a portable electronic device 100, embodying the present invention. The portable electronic device 100 (an electrical or electronic device) may be referred to as a battery-powered device or host device or consumer device. Example such devices include a mobile telephone or cellphone, a smartphone, an audio player, a video player, a PDA, a mobile computing platform such as a laptop computer or tablet, a games device, a wearable electronic device and a power tool.

As shown in FIG. 1, the device 100 may comprise an enclosure 101, a controller 110 and a battery 120. The device 100 may be provided without the battery 120 and be fitted with the battery 120 subsequently. The battery 120 may be referred to as a consumer battery.

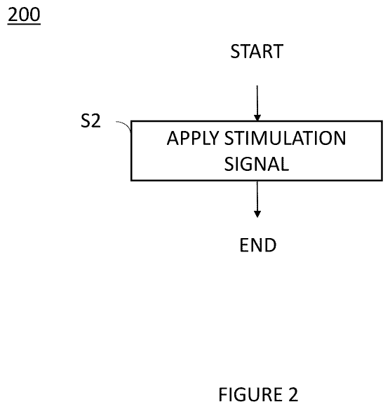

The controller 110 is configured to treat the battery, in particular to stimulate a mechanical response of the battery and may be referred to as battery-stimulation apparatus or simply stimulation apparatus. FIG. 2 is a flow diagram of a method 200 of treating (stimulating) the battery 120, embodying the present invention. Method 200 may be implemented in the portable electronic device 100, at least partly in the controller 110 (i.e., the stimulation apparatus).

In some arrangements, the controller 110 may also be an onboard charger for controlling charging of the battery 120. Power may be provided from an external power supply such as an external battery or mains power supply via a wired or wireless connection (not shown). The controller 110 may monitor battery characteristics including any of temperature T, battery capacity C, VB, OCV and SOC. The controller 110 may control the charging rate of the battery according to a charge profile which is dependent on those characteristics.

The enclosure 101 may comprise any suitable housing, casing, chassis or other enclosure for housing the various components of the device 100. Enclosure 101 may be constructed from plastic, metal, and/or any other suitable materials. In addition, enclosure 101 may in some arrangements be adapted (e.g., sized and shaped) such that device 100 is readily transported by a user (i.e. a person, a consumer).

The controller 110 may be housed within enclosure 101 and may include any system, device, or apparatus configured to control stimulation of the battery according to method 200, and optionally other functionality of the device 100 including charging of the battery 120.

Control functionality of the controller 110 may be implemented as digital or analogue circuitry, in hardware or in software running on a processor, or in any combination of these. Such control functionality may include any system, device, or apparatus configured to interpret and/or execute program instructions or code and/or process data, and may include, without limitation a processor, microprocessor, microcontroller, digital signal processor (DSP), application specific integrated circuit (ASIC), FPGA (Field Programmable Gate Array) or any other digital or analogue circuitry configured to interpret and/or execute program instructions and/or process data. Thus the code may comprise program code or microcode or, for example, code for setting up or controlling an ASIC or FPGA. The code may also comprise code for dynamically configuring re-configurable apparatus such as re-programmable logic gate arrays. Similarly, the code may comprise code for a hardware description language such as Verilog™ or VHDL. As the skilled person will appreciate, the code may be distributed between a plurality of coupled components in communication with one another. Where appropriate, such aspects may also be implemented using code running on a field-(re)programmable analogue array or similar device in order to configure analogue hardware. Processor control code for execution may be provided on a non-volatile carrier medium such as a disk, CD- or DVD-ROM, programmed memory such as read only memory (Firmware), or on a data carrier such as an optical or electrical signal carrier. Such control circuitry and may be provided as, or as part of, an integrated circuit such as an IC chip.

Although not shown in FIG. 1, the device 100 may comprise a further controller separate from the controller 110 but in communication therewith, such as an application processor configured to generally control operation of the device 100. Alternatively, the functionality of such a further controller may be provided by the controller 110. The device 100 may also comprise an input and/or output unit (I/O unit), for interaction with a user and/or with another device, and a memory. The memory may be configured to retain program instructions and/or data for a period of time, e.g. for the controller 110 (and any further controller).

The battery 120 may be a lithium battery or other rechargeable battery comprising positive and negative electrodes, connected to corresponding terminals of the battery, and an electrolyte.

Turning to FIG. 2, method 200 may be implemented at least partly in the controller 110 of the device 100 and comprises step S2 as shown.

In step S2, a stimulation signal is applied to at least one terminal of the battery, for example by the controller (stimulation apparatus) 110. Step S2 may comprise generating the stimulation signal; the controller 110 may itself generate the stimulation signal and apply the stimulation signal to the battery 120.

The stimulation signal may be a fluctuating or alternating (or varying) electrical signal, and thus may induce a fluctuating or alternating electric field between electrodes of the battery. The stimulation signal may induce a fluctuating or alternating potential difference across the terminals of the battery. The stimulation signal may be an AC signal and may be a voltage signal or a current signal. The stimulation signal is configured to induce a (measurable or detectable) mechanical response of the battery, such as a vibrational response. In particular, the stimulation signal is configured to induce a mechanical response of the battery (in particular, of one or more of its electrodes) sufficient to improve electrode wetting and/or for improving electrolyte wetting of electrodes of the battery. A frequency spectrum and/or electrical power of the stimulation signal may thus be configured for stimulating the mechanical response.

The stimulation signal may be a voltage signal with a peak amplitude between a lower voltage value and an upper voltage value. As an example, the lower voltage value may be between 5 mV and 15 mV, such as 10 mV. The upper voltage value may be between 250 mV and 2 V, such as 500 mV or 1 V. Peak amplitudes may be between 10 mV and 1 V.

The stimulation signal may be a current signal with a peak amplitude between a lower current value and an upper current value. As an example, the lower current value may be between 50 mA and 150 mA, such as 100 mA. The upper current value may be between 5 A and 20 A, such as 10 A.

A DC component of the stimulation signal may be substantially at 0 V, so that a low or negligible DC charging or discharging current flows in respect of the battery. For example, a DC component of the stimulation signal may be configured such that an associated DC charging or discharging current is at or below a tenth or a hundredth of a value which would fully charge/discharge the battery from empty/full within one hour.

Put another way, the DC current into or out of the battery 120 may be limited to below the rate of C/10 during the application of the stimulation signal. In this respect, the charge rate (specified for fully re-charging an empty battery) is often referenced to the battery capacity value, represented as C, where the charge capacity of the battery 120 may be understood to be the amount of charge the battery can hold. For example, a cellphone battery which can hold 3.2 Ah (3200 mAh) of charge when fully-charged can in theory (ignoring energy losses etc.) discharge from that state at a rate of 3.2 Amps for one hour before the battery has no usable charge remaining. Charging a battery at “1 C” means the battery can—in theory—be fully re-charged from empty in 1 hour by means of supplying the number of Amps in the charge capacity numeric value. Thus, for the example 3.2 Ah capacity battery, fully charging the battery (cell) at 1.0 C (i.e. from empty) corresponds to charging it (for 1 hour) at a constant charge rate of 3.2 Amps, fully charging it at 2.0 C corresponds to charging it (for 30 minutes) at a constant charge rate of 6.4 Amps, and fully charging it at 0.1 C (or C/10) corresponds to charging it (for 10 hours) at a constant charge rate of 0.32 Amps.

The stimulation signal may be configured such that its frequency spectrum or configuration or composition is substantially constant over time or is time-varying. The stimulation signal may have a peak/dominant frequency, or a plurality of peak/dominant frequencies, where the or each peak/dominant frequency is selected to stimulate the mechanical response of the battery 120. Such a peak/dominant frequency may be known or configured in advance, for example determined by experimentation on batteries of a specific type. The peak/dominant frequency or frequencies may be changed over time, for example to different frequencies for stimulating a suitable mechanical response of the battery 120 or to different frequencies where at least one is for stimulating a suitable mechanical response of the battery 120.

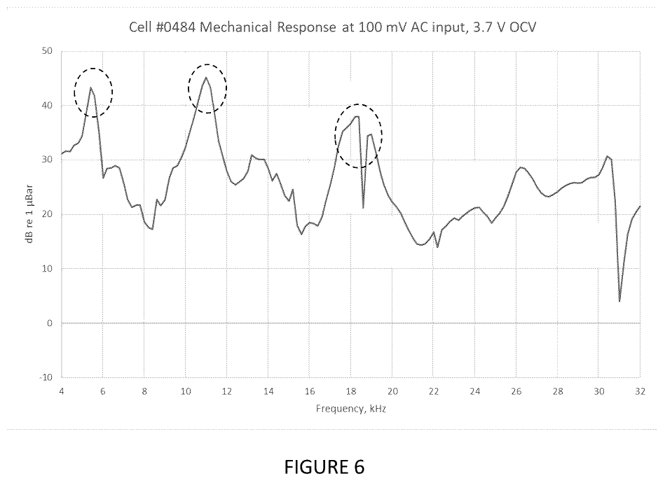

The stimulation signal may have a periodic waveform in the time domain. For example, the stimulation signal may have a sinusoidal, square or triangular waveform in the time domain. The stimulation signal may be a frequency-modulated signal centered at a vibrational response peak (a peak/dominant frequency) and with a bandwidth, the vibrational response peak and the bandwidth selected to stimulate the mechanical response. The bandwidth of the frequency-modulated signal may be similar to that of the vibrational response peak. For example, looking ahead to FIG. 6 which is described later in more detail, if there is for example a vibrational response peak at 11 kHz with a bandwidth of 1 kHz, then the frequency-modulated signal may be centered at approximately 11 kHz and have a bandwidth of approximately 1 kHz.

The stimulation signal may have a peak/dominant frequency or a plurality of peak/dominant frequencies which are: greater than or equal to 100 Hz; and/or between 1 kHz and 200 kHz; and/or between 10 KHz and 40 kHz; and/or greater than or equal to 10 KHz. The stimulation signal may comprise one or more sinusoidal waveforms with (peak/dominant) frequencies above 10 Hz or above 10 KHz. A frequency in a 10+ kHz range may be preferable as it may help avoid cycling charge in/out of electrodes, take advantage of wetting enhancement at high frequency, reduce the size of the storage capacitor for charge cycling, and reduce potential audible noise.

In some arrangements, e.g. where the stimulation signal is or comprises a sinusoidal signal, the method 200 may comprise sweeping or stepping a peak/dominant frequency of the stimulation signal between a lower frequency value and an upper frequency value. As an example, the lower frequency value may be 10 KHz. The upper frequency value may be 40 kHz. Of course, such stepping or sweeping may be in a single frequency direction (i.e. up or down in frequency), or “randomly walked” (i.e. a plurality of different frequencies may be employed in any order). Also, as above, multiple frequencies could be employed at the same time.

The method 200 may involve applying the stimulation signal in step S2 for a treatment period. A duration D of the treatment period in seconds may be set such that: D≥10, or D≥60, or D≥300, or D≥600, or D≥1800. The duration D of the treatment period in seconds may be set such that 10≤D≤30, or 30≤D≤120, or 60≤D≤300, or 600≤D≤1800. An example duration may be 15 minutes.

Many factors may affect the mechanical response of the battery 120 to the measurement signal. For example, the mechanical response may be affected by one or more of a temperature T of the battery 120; a state of charge SOC of the battery 120; a state of health SOH of the battery 120; one or more dimensions of the battery 120 (for example, as defined by its make and model); an impedance of the battery 120; a mounting configuration of the battery 120 within the portable electronic device 100; and a pressure or constraint applied to the battery 120. Method 200 may thus comprise measuring or recording (as appropriate) one or more of these factors, using a sensor (not shown) where needed, for use in configuring the stimulation signal. Such factors may be measured/recorded in advance of applying the stimulation signal. The stimulation signal and/or the duration D may be configured based on at least one of such factors.

As above, any of the above factors may be known, recorded or measured in advance of applying the stimulation signal. Similarly, a frequency configuration (frequency spectrum or peak/dominant frequenc(ies)) of the stimulation signal may be known, recorded or determined in advance of applying the stimulation signal, for example based on a frequency analysis of the battery 120. Similarly, the duration D may be known or recorded or determined in advance of applying the stimulation signal. The method 200 may comprise configuring the stimulation signal and/or the duration D based on a stored configuration setting. The method 200 may comprise selecting the stored configuration setting from a plurality of stored configuration settings based on at least one of: a make and/or model of the portable electronic device; and/or a make and/or model of the battery.

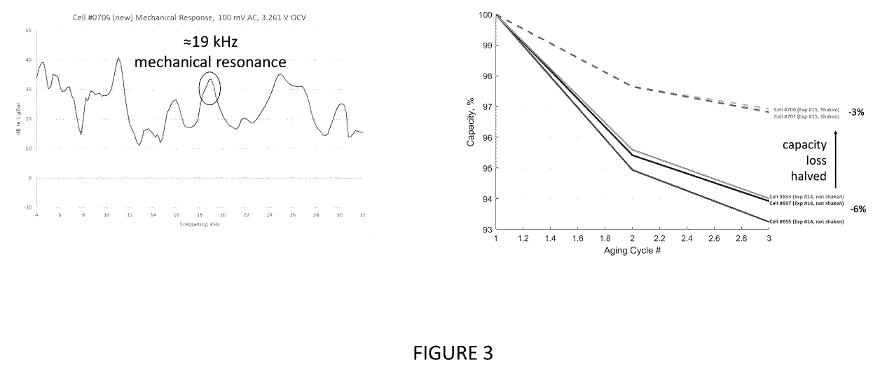

FIG. 3 comprises two graphs side-by-side, the left-hand graph showing an example frequency analysis performed on a reference battery 120 and the right-hand graph showing the effect of applying a stimulation signal according to method 200 on battery capacity.

Starting with the left-hand graph, it is assumed that a sinusoidal stimulation signal (or other periodic waveform having a peak/dominant frequency) was applied to the reference battery 120, and that the peak/dominant frequency of the stimulation signal was swept or stepped between 4 and 32 kHz, in 200 Hz steps, according to method 200 and using the portable electronic device 100. A sensor (not shown) of the portable electronic device 100 was also employed to measure the magnitude or power of the mechanical response (in decibels relative to 1 uBar set at 0 dB, dB re 1 uBar), as indicated. Example such sensors are explored in more detail later herein. As shown, based on the results of the frequency analysis, the frequency of 19 kHz was identified as a frequency of mechanical resonance of the battery 120, and therefore as a suitable frequency to employ in the stimulation signal.

Turning to the right-hand graph, plots of battery capacity over a series of experimental charging cycles are shown, for five different batteries of the same type as subjected to the frequency analysis of the left-hand graph. That is, each battery was subjected to a series of charging cycles, referred to as “aging cycles” as they were each carried out at 2.0 C (i.e. charged from empty to full and then discharged back to empty). The batteries are identified in the graph by their cell numbers #706, #707, #653, #657 and #655.

In the experiments, each battery was new (i.e. an unused consumer battery) prior to the series of charging cycles. Batteries #706 and #707 were each subjected to a sinusoidal stimulation signal—a 120 mV AC signal—with a peak/dominant frequency of 19 kHz for 15 minutes, according to method 200, prior to the series of charging cycles. Batteries #653, #657 and #655, however, were not subjected to a stimulation signal.

As can be seen from the right-hand graph, the battery capacity for all of the batteries under test reduced over the charging cycles. However, there is a marked difference between batteries #706 and #707 (which were each subjected to a sinusoidal stimulation signal) and batteries #653, #657 and #655 (which were not). In particular, for the latter set of batteries the battery capacity reduced by around 6% whereas for the former set it reduced by only around 3%, representing a halving in the loss of battery capacity as a result of the application of the stimulation signal.

As mentioned earlier, a frequency configuration (frequency spectrum or peak/dominant frequenc(ies)) of the stimulation signal may be known, recorded or determined in advance of applying the stimulation signal. The stimulation signal may be configured based on a frequency analysis of the battery 120 or of another battery of the same type.

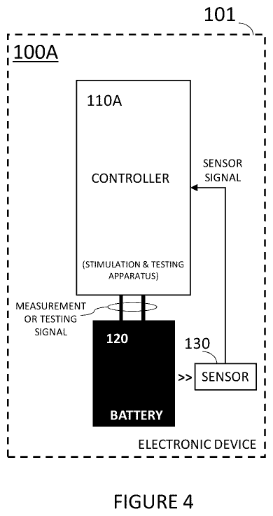

FIG. 4 is a schematic diagram of a portable electronic device 100A, embodying the present invention. The portable electronic device 100A may be considered a variation of the portable electronic device 100. Portable electronic device 100A is generally the same as portable electronic device 100, except that the controller 110 is replaced with a variant controller 110A and that a sensor 130 is provided. As such, duplicate description is omitted.

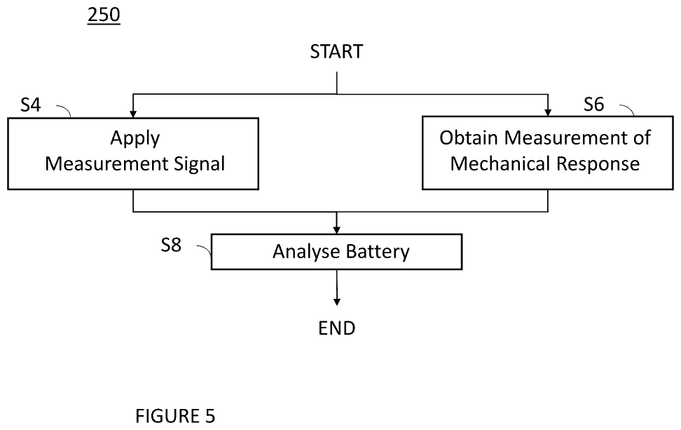

The controller 110A has the same functionality as controller 100 (i.e. it is configured to carry out method 200 of FIG. 2) but is also configured to test the battery and may also be referred to as battery-testing apparatus or testing apparatus or stimulation and testing apparatus. FIG. 5 is a flow diagram of a method 250 of testing the battery 120, embodying the present invention. Method 250 may be implemented in the portable electronic device 100A, at least partly in the controller 110A (i.e., the testing apparatus).

Control functionality of the controller 110A may be implemented as digital or analogue circuitry, in hardware or in software running on a processor, or in any combination of these, as for controller 110.

Turning to FIG. 5, method 250 may be implemented at least partly in the controller 110A of the device 100A and comprises steps S4, S6 and S8 as shown. Method 250 may be carried out prior to method 200, in order to determine, in step S8, how to configure the stimulation signal of step S2 of method 200.

In step S4, a measurement signal is applied to at least one terminal of the battery, for example by the controller 110A. That is, the measurement signal may be applied to the terminal(s) of the battery 120 by battery-testing apparatus of the portable electronic device 100A. Step S4 may comprise generating the measurement signal; the controller 110A may generate the measurement signal and apply the measurement signal to the battery 120.

The measurement signal may be a fluctuating or alternating (or varying) electrical signal, in the same way that the stimulation signal may be, and thus duplicate description will be omitted. The measurement signal is configured to induce a (measurable or detectable) mechanical response of the battery, such as a vibrational response.

Step S6 comprises obtaining a measurement of the mechanical response of the battery to the measurement signal from the sensor 130. Steps S4 and S6 may therefore be carried out in parallel, simultaneously or concurrently. Method 250 may comprise obtaining the measurement of the mechanical response of the battery 120 to the measurement signal while applying the measurement signal.

The sensor 130 may be any sensor capable of detecting the mechanical response of the battery 120 to the measurement signal and generating a sensor signal indicative of the mechanical response. For example, the sensor 130 may comprise at least one of: a microphone; an accelerometer, an inertial measurement unit, a motion sensor; a speaker; a piezoelectric sensor; a force sensor; a virtual button implemented by a force sensor; and an electromechanical actuator such an LRA.

The sensor 130 is shown in FIG. 4 as being a sensor of the device 100A, coupled to the battery 120 such that it senses the mechanical response, and providing its sensor signal to the controller 110A. The controller 110A in this way receives information (a vibrational response) from the sensor output indicative of the mechanical response. The skilled person will understand that any of the above example sensors may be provided within or on the enclosure 101 of the device 100A such that they pick up the mechanical response. The sensor 130 may be mechanically coupled directly to the battery or to a part of the device 100A to which the battery is (directly) mechanically coupled when in use. The sensor 130 may be coupled to the battery 120 via mechanical linkage provided by structural components of the (host) device 100A. The sensor 130 may be coupled to the battery by a combination of parts of the device 100A and air. Of course, the sensor 130 may be provided separately from the device 100A, e.g., in separate testing equipment. Where the sensor 130 is provided separately, the device 100A (in particular the controller 110A) may be configured to receive the sensor signal from the sensor 130.

Taking into account the combination of the controller 110A and the sensor 130, step S6 may comprise measuring the mechanical response of the battery 120 to the measurement signal with the sensor 130. Considering the controller 110A alone, step S6 may comprise obtaining a measurement of the mechanical response of the battery to the measurement signal from the sensor 130 as mentioned earlier, i.e., obtaining the sensor signal from the sensor 130.

As above, the measurement signal is configured to induce a (measurable or detectable) mechanical response of the battery, such as a vibrational response. As with the stimulation signal, the measurement signal may be a voltage signal with a peak amplitude between a lower voltage value and an upper voltage value, or may be a current signal with a peak amplitude between a lower current value and an upper current value.

The measurement signal may be configured such that its frequency spectrum is substantially constant over time or is time-varying. The measurement signal may for example have a peak/dominant frequency, or a plurality of peak/dominant frequencies, where the or each peak/dominant frequency is selected to at least temporarily stimulate the mechanical response of the battery 120. The measurement signal may have a periodic waveform in the time domain. For example, the measurement signal may have a sinusoidal, square or triangular waveform in the time domain. The measurement signal may be a frequency-modulated signal centered at a vibrational response peak (a peak/dominant frequency) and with a bandwidth, the vibrational response peak and the bandwidth selected to stimulate the mechanical response. The measurement signal may comprise one or more sinusoidal waveforms with (peak/dominant) frequencies above 10 Hz.

The measurement signal may be configured so that it has one or more different frequency spectra or peak/dominant frequencies over time. In such a case, the measurement of the mechanical response of the battery to the measurement signal may be obtained for each of the one or more different frequency spectra or peak/dominant frequencies. In some arrangements, e.g. where the measurement signal is or comprises a sinusoidal signal, the method 250 may comprise sweeping or stepping a frequency of the measurement signal between a lower test frequency value and an upper test frequency value and obtaining the measurement of the mechanical response of the battery 120 to the measurement signal for at least a plurality of different values of said frequency as it is swept or stepped. Effectively, the obtained measurement (or test results) may take the form of a frequency response. As an example, the lower test frequency value may be between 500 Hz and 2 kHz, such as 1 kHz. The upper test frequency value may be between 30 KHz and 100 kHz, such as 40 kHz, or between 100 KHz and 300 kHz, such as 200 kHz. Another example frequency range (lower test frequency value to upper test frequency value) may be 4 kHz to 32 kHz. Test frequencies above 10 Hz may be considered. As before, such stepping or sweeping may be in a single frequency direction (i.e. up or down in frequency), or “randomly walked” (i.e. a plurality of different frequencies may be tested in any order). Also, as above, multiple frequencies could be tested at the same time.

Step S8 comprises analysing the battery 120 based on the measurement of the mechanical response (or the measurement signal and the measurement of the mechanical response), i.e., based on the test results. In particular, step S8 comprises determining a frequency configuration (frequency spectrum or peak/dominant frequenc(ies)) of the stimulation signal based on the test results.

FIG. 6 is a graph showing example test results of testing according to method 250 using the portable electronic device 100. The battery 120 concerned in this case may be considered the battery to be subjected to method 200 or may be a reference battery of the same type (a reference cell).

It is assumed that a sinusoidal measurement signal (or other periodic waveform having a peak/dominant frequency) was employed, and the peak/dominant frequency of the measurement signal was swept or stepped between 4 and 32 kHz, and that the sensor signal received from the sensor 130 was used to plot the magnitude or power of the mechanical response (in decibels, dB) as indicated.

Analysing the battery based on the measurement of the mechanical response (or the measurement signal and the measurement of the mechanical response) in step S8 may take various forms. As ringed in FIG. 6, for example, the position of peaks in the frequency response (mechanical response vs frequency plot) may be identified, and these may be recorded as indicative of suitable peak/dominant frequenc(ies)) of the stimulation signal. That is, the peaks may identify frequencies at which the battery (in particular, battery electrodes) may be deliberately vibrated in an efficient manner.

It will be appreciated that it is not necessary to generate a full frequency response as indicated in FIG. 6; instead, power values at one or more discrete frequencies may be measured (using measurement signals having such peak/dominant frequencies), such as at the frequencies where the peaks appear in FIG. 6 if it is known or suspected (e.g. based on battery type) that such frequencies will give suitable results.

In general terms, therefore, step S8 may comprise analysing the battery 120 based on a relationship between the frequency spectrum or peak/dominant frequency or frequency of the measurement signal and the corresponding measured mechanical response. The relationship may be a measured relationship, and step S8 may comprise comparing the measured relationship with a corresponding reference relationship for a reference battery.

As mentioned earlier, many factors (mechanical-response factors) may affect the mechanical response of the battery 120 to the stimulation signal and the same may be true of the measurement signal. Example candidates include a temperature T of the battery 120; a state of charge SOC of the battery 120; a state of health SOH of the battery 120; one or more dimensions of the battery 120 (for example, as defined by its make and model); an impedance of the battery 120; a mounting configuration of the battery 120 within the portable electronic device 100; and a pressure or constraint applied to the battery 120.

Method 250 may thus comprise measuring or recording (as appropriate) one or more of these factors, using a sensor where needed (which could be sensor 130 or an additional sensor), for use in interpreting or analysing the sensor signal (i.e. the detected mechanical response). Step S8 may thus involve employing an algorithm or formula which is a function of one or more of these factors. That is, the method 250 may comprise analysing the battery based on one or more such factors (mechanical-response factors).

It will therefore be appreciated that the techniques disclosed herein provide for non-invasive telemetry of a battery/cell. The measurement does not affect, and can be performed at any, state of charge SOC of a battery or cell; there is no need to target a specific SOC. Further, the techniques can be carried out using an existing sensor 130 of the portable electronic device 100A (.g., an accelerometer, multi-axis IMUs, microphone), or via a relatively inexpensive added sensor e.g., a 1-axis MEMS accelerometer.

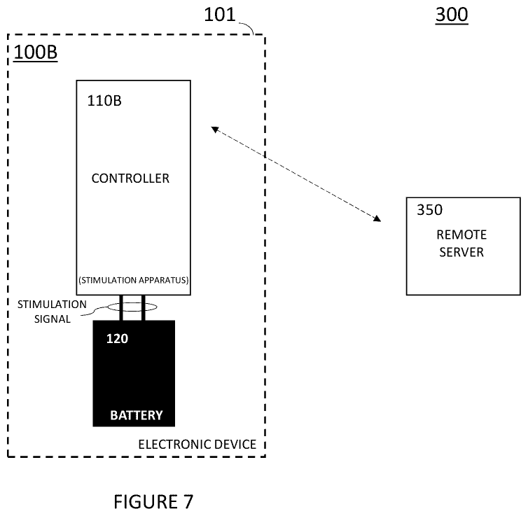

FIG. 7 is a schematic diagram of a system 300, embodying the present invention, comprising a portable electronic device 100B and a remote server (remote computing apparatus) 350. The remote server 350 may be communicatively coupled to the portable electronic device 100B, for example via a network, over wired or wireless communication links. The portable electronic device 100B, itself embodying the present invention, may be considered a variation of the portable electronic device 100. The remote server 300 may itself embody the present invention.

Portable electronic device 100B is generally the same as portable electronic device 100, except that controller 110 is replaced with a variant controller 110B. As such, duplicate description is omitted. In overview, the functionality of the controller (stimulation apparatus) 110 may be distributed between the controller 110B and the remote server 350. That is, the combination of the controller 110B and the remote server 350 may be considered stimulation apparatus corresponding to controller 110. Method 200 may be implemented in the system 300, i.e. by the portable electronic device 100B (in particular, controller 110B) in combination with the remote server 350.

In an example, step S2 may be partly carried out in the server 350. For example, the server 350 may provide the controller 110B with one or more configuration values to configure the stimulation signal of step S2, and the controller 110B may apply the stimulation signal to the battery 120 configured by those configuration values.

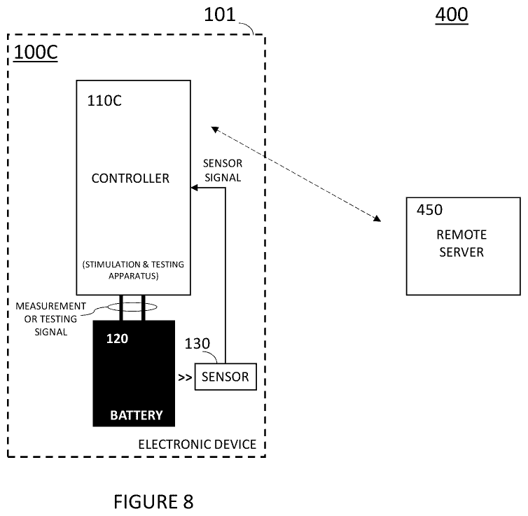

FIG. 8 is a schematic diagram of a system 400, embodying the present invention, comprising a portable electronic device 100C and a remote server (remote computing apparatus) 450. The remote server 450 may be communicatively coupled to the portable electronic device 100C, for example via a network, over wired or wireless communication links. The portable electronic device 100C, itself embodying the present invention, may be considered a variation of the portable electronic device 100A. The remote server 450 may itself embody the present invention and may be a variation of the remote server 350.

Portable electronic device 100C is generally the same as portable electronic device 100A, except that controller 110A is replaced with a variant controller 110C. As such, duplicate description is omitted. In overview, the functionality of the controller (stimulation apparatus) 110A may be distributed between the controller 110C and the remote server 450. That is, the combination of the controller 110C and the remote server 450 may be considered stimulation and testing apparatus corresponding to controller 110A. Methods 200 and 250 may be implemented in the system 400, i.e. by the portable electronic device 100C (in particular, controller 110C) in combination with the remote server 450.

In an example, step S2 may be partly carried out in the server 450. For example, the server 450 may provide the controller 110B with one or more configuration values to configure the stimulation signal of step S2, and the controller 110B may apply the stimulation signal to the battery 120 configured by those configuration values.

In another example, step S8 may be carried out in the server 450. That is, in some arrangements the measurement results of step S6 (i.e. based on the sensor signal from the sensor 130), and optionally also details of the measurement signal of step S2 (and any other mechanical-response factors as mentioned earlier), may be provided to the server 450, based on which the server may carry out step S8. Of course, step S8 may be split/divided between the controller 110C and server 450 in another way.

Control functionality of the remote server 350 or 450 may be implemented as digital or analogue circuitry, in hardware or in software running on a processor, or in any combination of these. Such control functionality may include any system, device, or apparatus configured to interpret and/or execute program instructions or code and/or process data, and may include, without limitation a processor, microprocessor, microcontroller, digital signal processor (DSP), application specific integrated circuit (ASIC), FPGA (Field Programmable Gate Array) or any other digital or analogue circuitry configured to interpret and/or execute program instructions and/or process data. Thus the code may comprise program code or microcode or, for example, code for setting up or controlling an ASIC or FPGA. The code may also comprise code for dynamically configuring re-configurable apparatus such as re-programmable logic gate arrays. Similarly, the code may comprise code for a hardware description language such as Verilog™ or VHDL. As the skilled person will appreciate, the code may be distributed between a plurality of coupled components in communication with one another. Where appropriate, such aspects may also be implemented using code running on a field-(re)programmable analogue array or similar device in order to configure analogue hardware. Processor control code for execution may be provided on a non-volatile carrier medium such as a disk, CD- or DVD-ROM, programmed memory such as read only memory (Firmware), or on a data carrier such as an optical or electrical signal carrier. Such control circuitry and may be provided as, or as part of, an integrated circuit such as an IC chip.

In some arrangements, the stimulation apparatus of FIGS. 1 and 7, or the stimulation and testing apparatus of FIGS. 4 and 8, may be provided separately from other components of the portable electronic device or system concerned. Such apparatus, for use by a portable electronic device, may be configured to carry out any of the methods disclosed herein, such as method 200 or 250 (or steps thereof) as described earlier. Such testing apparatus may be implemented as a single integrated circuit or as a group of integrated circuits.

The battery 120, as mentioned above, may comprise a battery cell and/or may be a single-cell battery. The battery 120 may comprise a plurality of battery cells. The battery 120 may be a commercially available battery, or consumer battery, or customer-ready battery or end-user-ready battery. The battery 120 may be a pouch cell or prismatic cell battery. The portable electronic devices disclosed herein may be considered a handheld portable electronic device and/or a mobile electronic device. The portable electronic devices disclosed herein may be considered a consumer device. The skilled person will appreciate that references to a portable electronic device herein could be replaced with references to an electrical or electronic device or system or to a mobile electrical or electronic device or system. Examples of such electronic devices may include cellphones, laptops, tablet computers, wearable electronic devices, power tools, and computing apparatus.

Although electrode wetting is focused on earlier herein, the inventors have recognised that this is one example of a characteristic of the battery which may be improved by stimulating a mechanical response of one or more of its electrodes. More generally, there may be provided a method of stimulating a target mechanical response of a battery of a portable electronic device, or a method of improving a property of a battery of a portable electronic device, the method comprising applying a fluctuating or alternating electrical signal to at least one terminal of the battery to stimulate a target mechanical response or mechanical response of the battery. Such methods may be implemented by the portable electronic device or battery-stimulation apparatus thereof.

As above, the battery-stimulation apparatus (or stimulation apparatus or stimulation and testing apparatus) may be provided separately for use by the portable electronic device. Such apparatus may be implemented as a single integrated circuit or as a group of integrated circuits communicatively coupled together.

The skilled person will recognise that some aspects of the above-described apparatus (circuitry), devices and methods may be embodied as processor control code, for example on a non-volatile carrier medium such as a disk, CD- or DVD-ROM, programmed memory such as read only memory (Firmware), or on a data carrier such as an optical or electrical signal carrier. For example, any of the controllers 110, 110A, 110B and 110C and the servers 350 and 450 may be implemented as a processor operating based on processor control code.

For some applications, such aspects will be implemented on a DSP (Digital Signal Processor), ASIC (Application Specific Integrated Circuit) or FPGA (Field Programmable Gate Array). Thus the code may comprise conventional program code or microcode or, for example, code for setting up or controlling an ASIC or FPGA. The code may also comprise code for dynamically configuring re-configurable apparatus such as re-programmable logic gate arrays. Similarly, the code may comprise code for a hardware description language such as Verilog™ or VHDL. As the skilled person will appreciate, the code may be distributed between a plurality of coupled components in communication with one another. Where appropriate, such aspects may also be implemented using code running on a field-(re)programmable analogue array or similar device in order to configure analogue hardware.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in the claim, “a” or “an” does not exclude a plurality, and a single feature or other unit may fulfil the functions of several units recited in the claims. Any reference numerals or labels in the claims shall not be construed so as to limit their scope.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

It should be understood—especially by those having ordinary skill in the art with the benefit of this disclosure—that the various operations described herein, particularly in connection with the figures, may be implemented by other circuitry or other hardware components. The order in which each operation of a given method is performed may be changed, and various elements of the systems illustrated herein may be added, reordered, combined, omitted, modified, etc. It is intended that this disclosure embrace all such modifications and changes and, accordingly, the above description should be regarded in an illustrative rather than a restrictive sense.

Similarly, although this disclosure makes reference to specific embodiments, certain modifications and changes can be made to those embodiments without departing from the scope and coverage of this disclosure. Moreover, any benefits, advantages, or solutions to problems that are described herein with regard to specific embodiments are not intended to be construed as a critical, required, or essential feature or element. Further embodiments likewise, with the benefit of this disclosure, will be apparent to those having ordinary skill in the art, and such embodiments should be deemed as being encompassed herein.

To aid the Patent Office (USPTO) and any readers of any patent issued on this application in interpreting the claims appended hereto, applicants wish to note that they do not intend any of the appended claims or claim elements to invoke 35 U.S.C. § 112 (f) unless the words “means for” or “step for” are explicitly used in the particular claim.

The present disclosure extends to the following statements:

S1. A method of improving electrode wetting of a battery of a portable electronic device, the method implemented by the portable electronic device or battery-stimulation apparatus thereof, the method comprising:
applying a stimulation signal, being a fluctuating or alternating electrical signal, to at least one terminal of the battery to stimulate a mechanical response of electrodes of the battery.

S2. The method of statement S1, wherein the mechanical response is a vibrational response.

S3. The method of statement S1 or S2, wherein the mechanical response is for improving electrolyte wetting of electrodes of the battery.

S4. The method of any of the preceding statements, wherein a frequency spectrum and/or electrical power of the stimulation signal is configured for stimulating the mechanical response.

S5. The method of any of the preceding statements, wherein the stimulation signal is configured to induce a fluctuating or alternating electric field between electrodes of the battery.

S6. The method of any of the preceding statements, wherein the stimulation signal is configured to induce a fluctuating or alternating potential difference across the terminals of the battery and/or between electrodes of the battery.

S7. The method of any of the preceding statements, wherein the stimulation signal is:
an AC signal; and/or
a voltage signal or a current signal.

S8. The method of any of the preceding statements, wherein a DC component of the stimulation signal is:
substantially at 0 V; and/or
at or below a tenth or a hundredth of a value which would cause a charging current to flow which would charge the battery from empty within one hour; and/or
at or below a tenth or a hundredth of a value which would cause a discharging current to flow which would empty the battery from full within one hour.

S9. The method of any of the preceding statements, wherein the stimulation signal is a voltage signal with a peak amplitude between a lower voltage value and an upper voltage value, optionally wherein:
the lower voltage value is between 5 mV and 15 mV, such as 10 mV; and/or
the upper voltage value is between 250 mV and 2 V, such as 500 mV or 1V.

S10. The method of any of the preceding statements, wherein the stimulation signal is a current signal with a peak amplitude between a lower current value and an upper current value, optionally wherein:
the lower current value is between 50 mA and 150 mA, such as 100 mA; and/or
the upper current value is between 5 A and 20 A, such as 10 A.

S11. The method of any of the preceding statements, wherein the method comprises generating the stimulation signal.

S12. The method of any of the preceding statements, wherein the stimulation signal is configured such that its frequency spectrum is substantially constant over time or is time-varying.

S13. The method of any of the preceding statements, wherein the stimulation signal has a peak/dominant frequency, or a plurality of peak/dominant frequencies, and wherein each peak/dominant frequency is selected or controlled to stimulate said mechanical response.

S14. The method of any of the preceding statements, wherein the stimulation signal has a periodic waveform in the time domain.

S15. The method of any of the preceding statements, wherein:
the stimulation signal has a sinusoidal, square or triangular waveform in the time domain; and/or
is a frequency-modulated signal centered at a vibrational response peak and with a bandwidth, the vibrational response peak and the bandwidth selected or controlled to stimulate said mechanical response, optionally wherein the bandwidth is substantially similar to that of the vibrational response peak.

S16. The method of any of the preceding statements, wherein the stimulation signal has a peak/dominant frequency or a plurality of peak/dominant frequencies which are:
greater than or equal to 100 Hz; and/or
between 1 kHz and 200 kHz; and/or
between 10 KHz and 40 kHz; and/or
greater than or equal to 10 KHz.

S17. The method of any of the preceding statements, comprising applying said stimulation signal for a treatment period.

S18. The method of any of the preceding statements, wherein a duration D of said treatment period in seconds is set such that:
D≥10, or D≥60, or D≥300, or D≥600, or D≥1800; and/or
10≤D≤30, or 30≤D≤120, or 60≤D≤300, or 600≤D≤1800.

S19. The method of any of the preceding statements, comprising configuring the stimulation signal and/or the duration D based on at least one of:
a temperature T of the battery;
a state of charge SOC of the battery;
a state of health SOH of the battery;
one or more dimensions of the battery;
an impedance of the battery;
a mounting configuration of the battery within the portable electronic device; and
a pressure or constraint applied to the battery.

S20. The method of any of the preceding statements, comprising configuring the stimulation signal and/or the duration D based on a stored configuration setting, optionally wherein the method comprises selecting the stored configuration setting from a plurality of stored configuration settings based on at least one of:
a make and/or model of the portable electronic device; and/or
a make and/or model of the battery.

S21. The method of any of the preceding statements, further comprising:
applying a measurement signal to at least one terminal of the battery, wherein the measurement signal is a fluctuating or alternating electrical signal;
obtaining a measurement of a mechanical response of the battery to the measurement signal from a sensor; and
configuring said stimulation signal based on the measurement signal and the corresponding measured mechanical response.

S22. The method of statement S21, comprising obtaining the measurement of the mechanical response of the battery to the measurement signal while applying the measurement signal.

S23. The method of statement S21 or S22, wherein the sensor is a sensor of the portable electronic device.

S24. The method of any of statements S21 to S23, wherein the sensor comprises at least one of:
a microphone;
an accelerometer,
an inertial measurement unit,
a motion sensor;
a speaker;
a piezoelectric sensor;
a force sensor;
a virtual button implemented by a force sensor; and
an electromechanical actuator such as an LRA.

S25. The method of any of statements S21 to S24, wherein the method comprises:
configuring the measurement signal so that it has one or more different frequency spectra or peak/dominant frequencies over time and/or so that it has one or more different peak/dominant frequencies at the same time; and
obtaining the measurement of the mechanical response of the battery to the measurement signal for each of said one or more different frequency spectra or peak/dominant frequencies.

S26. The method of any of statements S21 to S25, wherein:
the measurement signal is a sinusoidal signal; and/or
the method comprises sweeping or stepping a frequency of the measurement signal between a lower test frequency value and an upper test frequency value and measuring the mechanical response of the battery to the measurement signal for at least a plurality of different values of said frequency as it is swept or stepped,
optionally wherein:
the lower test frequency value is between 500 Hz and 2 kHz, such as 1 kHz; and/or
wherein the upper test frequency value is between 100 KHz and 300 kHz, such as 200 KHz.

S27. The method of any of statements S21 to S26, wherein the method comprises configuring said stimulation signal based on a relationship between the peak/dominant frequency of the measurement signal and the corresponding measured mechanical response.

S28. The method of any of statements S21 to S27, wherein the method comprises selecting one or more frequencies based on the relationship to be peak/dominant frequencies of the stimulation signal, and configuring the stimulation to have the selected one or more frequencies as its peak/dominant frequencies.

S29. The method of any of statements S21 to S28, wherein the method comprises measuring the mechanical response of the battery to the measurement signal with the sensor.

S30. The method of any of statements S21 to S29, wherein the measurement signal is applied to the at least one terminal of the battery by battery-analysis apparatus of the portable electronic device.

S31. A method of improving electrode wetting of a battery of a portable electronic device, the method implemented by the portable electronic device, the method comprising applying a fluctuating or alternating electrical signal to at least one terminal of the battery.

S32. The method according to any of the preceding statements, wherein:
the battery comprises a battery cell and/or is a single-cell battery; or
the battery comprises a plurality of battery cells; or
the portable electronic device is a handheld portable electronic device and/or a mobile electronic device.

S33. A method of stimulating a target mechanical response of a battery of a portable electronic device, the method comprising:
applying a stimulation signal to at least one terminal of the battery,
wherein the stimulation signal is a fluctuating or alternating electrical signal whose frequency spectrum and/or power is selected for stimulating the target mechanical response.

S34. The method of statement S33, wherein the method is implemented by the portable electronic device or battery-stimulation apparatus thereof.

S35. The method of statement S33 or S34, wherein the target mechanical response is a mechanical response of electrodes of the battery and is optionally a vibrational response.

S36. The method of any of statements S33 to S35, wherein the target mechanical response is for improving electrode wetting of the battery or for improving electrolyte wetting of electrodes of the battery.

S37. A method of stimulating a target mechanical response of a battery of a portable electronic device, the method implemented by the portable electronic device, the method comprising applying a fluctuating or alternating electrical signal to at least one terminal of the battery.

S38. A method of improving a characteristic of a battery of a portable electronic device, the method comprising:
applying a stimulation signal to at least one terminal of the battery,
wherein the stimulation signal is a fluctuating or alternating electrical signal whose frequency spectrum and/or power is selected for stimulating a mechanical response of the battery.

S39. Battery-stimulation apparatus for use by a portable electronic device to improve electrode wetting of a battery of a portable electronic device, the apparatus configured to carry out the method of any of the preceding statements, optionally wherein the apparatus is implemented as a single integrated circuit or as a group of integrated circuits communicatively coupled together.

S40. A portable electronic device comprising the battery-stimulation apparatus according to statement S39, and optionally comprising the battery.

S41. The portable electronic device of statement S40, being a cellphone, laptop, tablet computer, wearable electronic device, power tool or other personal device.

1. A method of improving electrode wetting of a battery of a portable electronic device, the method implemented by the portable electronic device or battery-stimulation apparatus thereof, the method comprising:
applying a stimulation signal, being a fluctuating or alternating electrical signal, to at least one terminal of the battery to stimulate a mechanical response of electrodes of the battery.

2. The method of claim 1, wherein the mechanical response is a vibrational response.

3. The method of claim 1, wherein the mechanical response is for improving electrolyte wetting of electrodes of the battery.

4. The method of claim 1, wherein a frequency spectrum and/or electrical power of the stimulation signal is configured for stimulating the mechanical response.

5. The method of claim 1, wherein the stimulation signal is configured to induce a fluctuating or alternating electric field between electrodes of the battery.

6. The method of claim 1, wherein a DC component of the stimulation signal is:
substantially at 0 V; and/or
at or below a tenth or a hundredth of a value which would cause a charging current to flow which would charge the battery from empty within one hour; and/or
at or below a tenth or a hundredth of a value which would cause a discharging current to flow which would empty the battery from full within one hour.

7. The method of claim 1, wherein the stimulation signal is a voltage signal with a peak amplitude between a lower voltage value and an upper voltage value, optionally wherein:
the lower voltage value is between 5 mV and 15 mV, such as 10 mV; and/or
the upper voltage value is between 250 mV and 2 V, such as 500 mV or 1 V.

8. The method of claim 1, wherein the stimulation signal is a current signal with a peak amplitude between a lower current value and an upper current value, optionally wherein:
the lower current value is between 50 mA and 150 mA, such as 100 mA; and/or
the upper current value is between 5 A and 20 A, such as 10 A.

9. The method of claim 1, wherein the stimulation signal is configured such that its frequency spectrum is substantially constant over time or is time-varying.

10. The method of claim 1, wherein the stimulation signal has a peak/dominant frequency, or a plurality of peak/dominant frequencies, and wherein each peak/dominant frequency is selected or controlled to stimulate said mechanical response.

11. The method of claim 1, wherein the stimulation signal has a peak/dominant frequency or a plurality of peak/dominant frequencies which are:
greater than or equal to 100 Hz; and/or
between 1 kHz and 200 kHz; and/or
between 10 KHz and 40 KHz; and/or
greater than or equal to 10 KHz.

12. The method of claim 1, comprising applying said stimulation signal for a treatment period, wherein a duration D of said treatment period in seconds is set such that:
D≥10, or D≥60, or D≥300, or D≥600, or D≥1800; and/or
10≤D≤30, or 30≤D≤120, or 60≤D≤300, or 600≤D≤1800.

13. The method of claim 1, comprising configuring the stimulation signal and/or the duration D based on at least one of:
a temperature T of the battery;
a state of charge SOC of the battery;
a state of health SOH of the battery;
one or more dimensions of the battery;
an impedance of the battery;
a mounting configuration of the battery within the portable electronic device; and
a pressure or constraint applied to the battery.

14. The method of claim 1, further comprising:
applying a measurement signal to at least one terminal of the battery, wherein the measurement signal is a fluctuating or alternating electrical signal;
obtaining a measurement of a mechanical response of the battery to the measurement signal from a sensor; and
configuring said stimulation signal based on the measurement signal and the corresponding measured mechanical response.

15. The method of claim 14, wherein the sensor is a sensor of the portable electronic device.

16. The method of claim 14, wherein the method comprises:
configuring the measurement signal so that it has one or more different frequency spectra or peak/dominant frequencies over time and/or so that it has one or more different peak/dominant frequencies at the same time; and
obtaining the measurement of the mechanical response of the battery to the measurement signal for each of said one or more different frequency spectra or peak/dominant frequencies.

17. The method of claim 14, wherein the method comprises configuring said stimulation signal based on a relationship between the peak/dominant frequency of the measurement signal and the corresponding measured mechanical response.

18. The method of claim 14, wherein the method comprises selecting one or more frequencies based on the relationship to be peak/dominant frequencies of the stimulation signal, and configuring the stimulation to have the selected one or more frequencies as its peak/dominant frequencies.

19. Battery-stimulation apparatus for use by a portable electronic device to improve electrode wetting of a battery of a portable electronic device, the apparatus configured to carry out the method of claim 1, optionally wherein the apparatus is implemented as a single integrated circuit or as a group of integrated circuits communicatively coupled together.

20. A portable electronic device comprising the battery-stimulation apparatus according to claim 19, and optionally comprising the battery.
